(19) United States
(12) Patent Application Publication
(10) Pub. No.: US 2013/0315361 A1
(43) Pub. Date: Nov. 28, 2013

(54) SYSTEMS AND METHODS FOR PROCESSING IRRADIATION TARGETS THROUGH MULTIPLE INSTRUMENTATION TUBES IN A NUCLEAR REACTOR

(71) Applicants: John F. Berger, Wilmington, NC (US); Earl F. Saito, Wilmington, NC (US); Yogeshwar Dayal, San Jose, CA (US); Martin W. Brittingham, Wilmington, NC (US); Jeffrey M. Hare, Wilmington, NC (US)

(72) Inventors: John F. Berger, Wilmington, NC (US); Earl F. Saito, Wilmington, NC (US); Yogeshwar Dayal, San Jose, CA (US); Martin W. Brittingham, Wilmington, NC (US); Jeffrey M. Hare, Wilmington, NC (US)

(21) Appl. No.: 13/477,244

(22) Filed: May 22, 2012

(51) Int. Cl. G21C 19/00; G21G 1/00

(52) U.S. Cl. 376/202; 376/156

(57) ABSTRACT

Apparatuses and methods produce radioisotopes in multiple instrumentation tubes of operating commercial nuclear reactors. Irradiation targets may be inserted and removed from multiple instrumentation tubes during operation and converted to radioisotopes otherwise unavailable during operation of commercial nuclear reactors. Example apparatuses may continuously insert, remove, and store irradiation targets to be converted to useable radioisotopes or other desired materials at several different origin and termination points accessible outside an access barrier such as a containment building, drywell wall, or other access restriction preventing access to instrumentation tubes during operation of the nuclear plant. Example systems can simultaneously maintain irradiation targets in multiple instrumentation tubes for desired irradiation followed by harvesting.

### GOVERNMENT SUPPORT

This invention was made with Government support under contract number DE-FC52-09NA29626, awarded by the U.S. Department of Energy. The Government has certain rights in the invention.

### BACKGROUND

Elements, and specific isotopes thereof, may be formed by bombarding parent materials with appropriate radiation to cause a conversion to desired daughter isotopes. For example, precious metals and/or radioisotopes may be formed through such bombardment. Conventionally, particle accelerators or specially-designed, non-commercial test reactors are used to achieve such bombardment and produce desired isotopes in relatively small amounts.

Radioisotopes have a variety of medical and industrial applications stemming from their ability to emit discreet amounts and types of ionizing radiation and form useful daughter products. For example, radioisotopes are useful in cancer-related therapy, medical imaging and labeling technology, cancer and other disease diagnosis, and medical sterilization.

Radioisotopes having half-lives on the order of days or hours are conventionally produced by bombarding stable parent isotopes in accelerators or low-power, non-electricity-generating reactors. These accelerators or reactors are on-site at medical or industrial facilities or at nearby production facilities. Especially short-lived radioisotopes must be quickly transported due to the relatively quick decay time and the exact amounts of radioisotopes needed in particular applications. Further, on-site production of radioisotopes generally requires cumbersome and expensive irradiation and extraction equipment, which may be cost-, space-, and/or safety-prohibitive at end-use facilities.

### SUMMARY

Example embodiments include systems for irradiating materials in multiple instrumentation tubes of a nuclear reactor so as to produce desired daughter products, including valuable isotopes and short-lived radioisotopes that can be readily harvested and used. Example systems include loading/offloading systems that are capable of switching between distinct loading and harvesting points for irradiation targets outside of an access barrier and are always accessible. The loading and harvesting points are also selectively connected to one of a plurality of pathways that each lead to an individual instrumentation tube that are not accessible. The selective connection is achieved by an indexer that is positionable anywhere along the pathways. For example, a single pathway may extend through the access barrier to an indexer positioned in the non-accessible area inside of the access barrier, or alternately outside the access barrier. Example systems further include retention mechanisms for keeping irradiation targets in instrumentation tubes while the system is reconfigured for loading/offloading other instrumentation tubes. For example, the indexer or a flange-based retention mechanism such as a valve, a pin, and/or a magnetic latch, or any other device can be used for retaining the targets in the instrumentation tubes during irradiation and prevent irradiation targets from moving out of (or into) instrumentation tubes. Example systems may use several different types of irradiation targets, including “dummy” or positioning targets that serve to take up necessary amount of space in pathways and instrumentation tubes to achieve desired axial positioning and/or tracking of irradiation targets. The various types of targets may be provided from a single source, such as reservoirs containing each type of target connected to a single pathway. Valves or other discriminating devices can properly introduce a desired number of each target into example systems. Through example systems, the targets can be inserted into multiple instrumentation tubes to produce a relatively larger amount of desired isotope and daughter product. Example systems are useable with a single drive system, origin point, and harvesting point for all instrument tubes. Because targets can be maintained in multiple instrumentation tubes, pathways between the tubes and harvesting/origin points can be sealed, providing enhanced isolation to areas within access barriers.

Example methods include methods of operating example systems to produce desired isotopes from targets loaded into multiple instrumentation tubes. For example, by properly configuring example systems to provide a pathway between an irradiation target origin point and an indexer that feeds to multiple instrumentation tubes, targets can be loaded into the multiple instrumentation tubes from a single origin point. Once loaded, retaining devices may be activated to hold irradiation targets within instrumentation tubes. Example systems may then be reconfigured automatically or manually by plant operators to provide different pathways to load other instrumentation tubes from the same origin point. By repeating the steps, multiple instrumentation tubes can be filled and simultaneously irradiated for radioisotope or other product creation as an operator desires. Similarly, all pathways may be selectively connected to a single harvesting point outside of an access area to harvest generated products in example systems.

### BRIEF DESCRIPTIONS OF THE DRAWINGS

Example embodiments will become more apparent by describing, in detail, the attached drawings, wherein like elements are represented by like reference numerals, which are given by way of illustration only and thus do not limit the terms which they depict.

FIG. 1 is an illustration of a conventional commercial nuclear reactor.

FIG. 2 is an illustration of an example embodiment irradiation target retrieval system in a loading configuration.

FIG. 3 is a detail view of an instrumentation tube filled with irradiation targets by example systems and methods.

### DETAILED DESCRIPTION

This is a patent document, and general broad rules of construction should be applied when reading and understanding it. Everything described and shown in this document is an example of subject matter falling within the scope of the appended claims. Any specific structural and functional details disclosed herein are merely for purposes of describing how to make and use example embodiments. Several different embodiments not specifically disclosed herein fall within the claim scope; as such, the claims may be embodied in many alternate forms and should not be construed as limited to only example embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected,” “coupled,” “mated,” “attached,” or “fixed” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.). Similarly, a term such as “communicatively connected” includes all variations of information exchange routes between two devices, including intermediary devices, networks, etc., connected wirelessly or not.

As used herein, the singular forms “a”, “an” and “the” are intended to include both the singular and plural forms, unless the language explicitly indicates otherwise with words like “only,” “single,” and/or “one.” It will be further understood that the terms “comprises”, “comprising,”, “includes” and/or “including”, when used herein, specify the presence of stated features, steps, operations, elements, ideas, and/or components, but do not themselves preclude the presence or addition of one or more other features, steps, operations, elements, components, ideas, and/or groups thereof.

It should also be noted that the structures and operations discussed below may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually or sequentially, so as to provide looping or other series of operations aside from the single operations described below. It should be presumed that any embodiment having features and functionality described below, in any workable combination, falls within the scope of example embodiments.

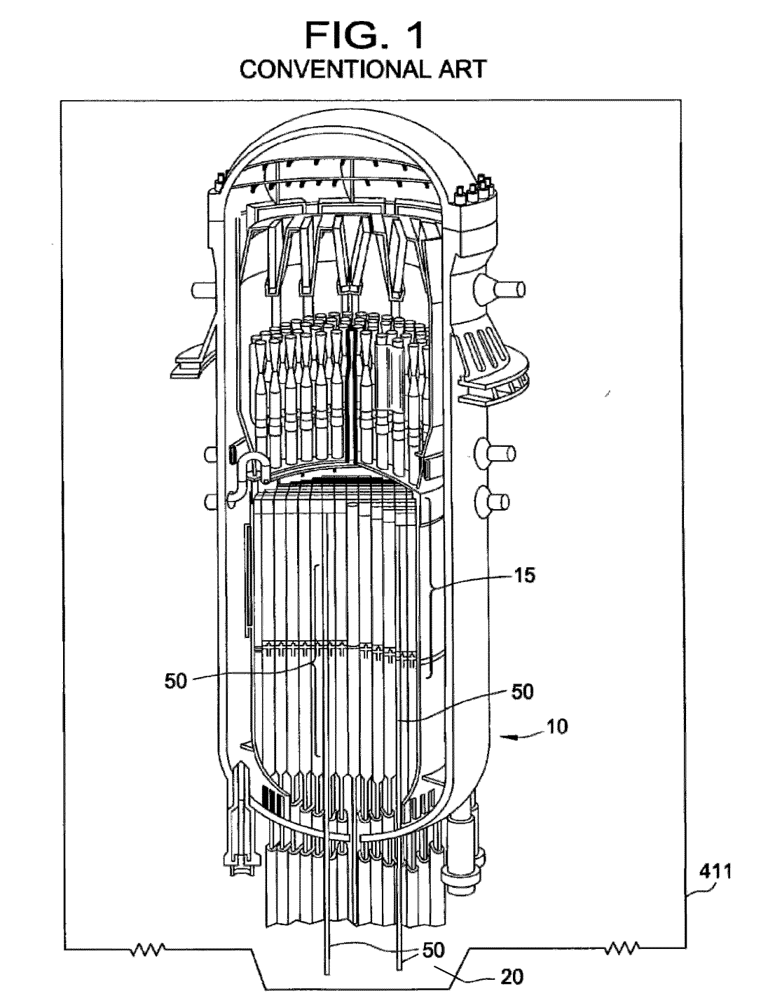

FIG. 1 is an illustration of a conventional nuclear reactor pressure vessel 10 usable with example embodiments and example methods. Reactor pressure vessel 10 may be, for example, a 100+MWe commercial light water nuclear reactor conventionally used for electricity generation throughout the world. Reactor pressure vessel 10 is conventionally contained within an access barrier 411 that serves to contain radioactivity in the case of an accident and prevent access to reactor 10 during operation of the reactor 10. As defined herein, an access barrier is any structure that prevents human access to an area during operation of the nuclear reactor due to safety or operational hazards such as radiation. As such, access barrier 411 may be a containment building sealed and inaccessible during reactor operation, a drywell wall surrounding an area around the reactor, a reactor shield wall, a human movement barrier preventing access to instrumentation tube 50, etc.

A cavity below the reactor vessel 10, known as a drywell 20, serves to house equipment servicing the vessel such as pumps, drains, instrumentation tubes, and/or control rod drives. As shown in FIG. 1 and as defined herein, at least one instrumentation tube 50 extends into the vessel 10 and near, into, or through core 15 containing nuclear fuel and relatively high levels of neutron flux and other radiation during operation of the core 15. As existing in conventional nuclear power reactors and as defined herein, instrumentation tubes 50 are enclosed within vessel 10 and open outside of vessel 10, permitting spatial access to positions proximate to core 15 from outside vessel 10 while still being physically separated from innards of the reactor and core by instrumentation tube 50. Instrumentation tubes 50 may be generally cylindrical and may widen with height of the vessel 10; however, other instrumentation tube geometries may be encountered in the industry. An instrumentation tube 50 may have an inner diameter of about 0.3 inch, for example.

Instrumentation tubes 50 may terminate below the reactor vessel 10 in the drywell 20. Conventionally, instrumentation tubes 50 may permit neutron detectors, and other types of detectors, to be inserted therein through an opening at a lower end in the drywell 20. These detectors may extend up through instrumentation tubes 50 to monitor conditions in the core 15. Examples of conventional monitor types include wide range detectors (WRNM), source range monitors (SRM), intermediate range monitors (IRM), and Traversing Incore Probes (TIP). Access to the instrumentation tubes 50 and any monitoring devices inserted therein is conventionally restricted to operational outages due to containment and radiation hazards.

Although vessel 10 is illustrated with components commonly found in a commercial Boiling Water Reactor, example embodiments and methods are useable with several different types of reactors having instrumentation tubes 50 or other access tubes that extend into the reactor. For example, Pressurized Water Reactors, Heavy-Water Reactors, Graphite-Moderated Reactors, etc. having a power rating from below 100 Megawatts-electric to several Gigawatts-electric and having instrumentation tubes at several different positions from those shown in FIG. 1 may be useable with example embodiments and methods. As such, instrumentation tubes useable in example methods may be at any geometry about the core that allows enclosed access to the flux of the nuclear core of various types of reactors.

Applicants have recognized a need for a maximized amount of radioisotope production within instrumentation tubes 50, but also identified that such need is limited by relatively few and sensitive pathways through access barrier 411 during operation. Example embodiments and methods address this problem by permitting irradiation targets 250 to be inserted into multiple instrumentation tubes 50 and exposing the irradiation targets to the core 15 while operating or producing radiation, thereby exposing the irradiation targets to the neutron flux and other radiation commonly encountered in the core 15. The core flux over time converts a substantial portion of the irradiation targets 250 to a useful mass of radioisotope, including short-term radioisotopes useable in medical applications. Irradiation targets 250 may then be withdrawn from the instrumentation tubes 50, even during ongoing operation of the core 15, and removed for medical and/or industrial use.

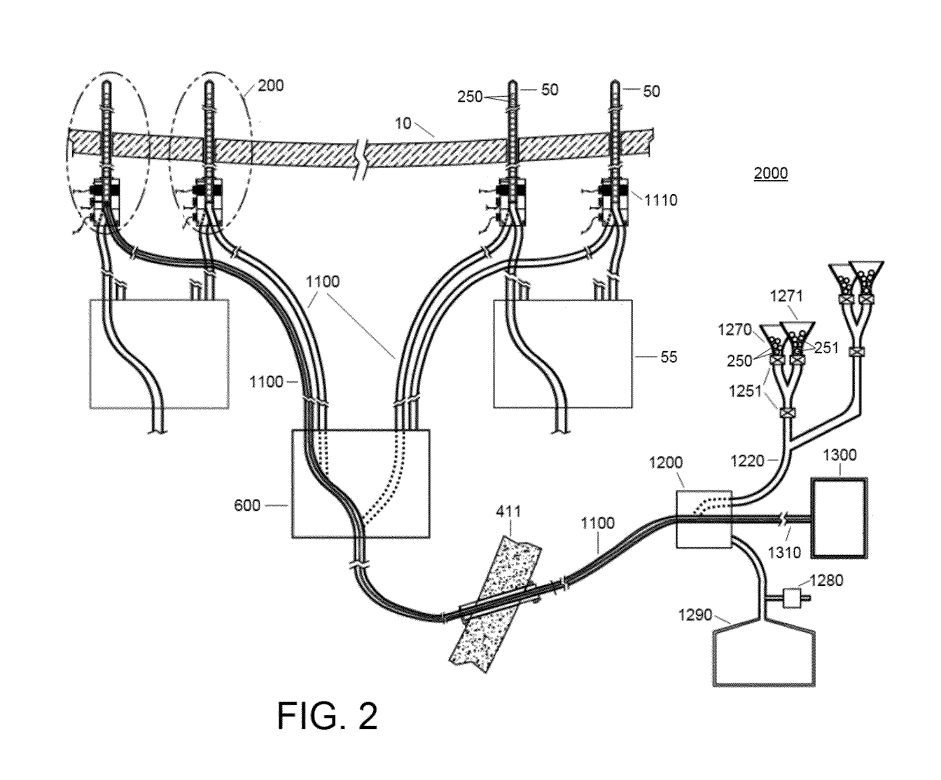

FIG. 2 is a schematic drawing of an example embodiment irradiation target delivery and retrieval system 2000 useable to simultaneously produce desired radioisotopes in multiple instrumentation tubes of a single nuclear reactor. Several details of example embodiment system 2000 are described with like numbering in co-pending application Ser. No. 13/339,345 filed Dec. 28, 2011 titled “Systems and Methods for Processing Irradiation Targets Through a Nuclear Reactor,” which is herein incorporated by reference in its entirety. Redundant details of example embodiment system 2000 discussed in connection with system 1000 of the incorporated applications are not repeated.

As shown in FIG. 2, example embodiment irradiation target delivery and retrieval system 2000 includes an instrumentation tube indexer 600 in penetration pathway 1100. Indexer 600 selectively directs irradiation targets 250 to one of multiple instrumentation tubes 50 within nuclear reactor 10 by making accessible a penetration pathway 1100 leading to the individual instrumentation tube 50. For example, tubing useable as penetration pathway 1100 may be divided at indexer 600 and diverge from a single pathway into multiple pathways each leading to a corresponding instrumentation tube 50. Indexer 600 may further selectively allow irradiation targets 250 from multiple instrumentation tubes 50 to enter into a single/combined penetration pathway 1100 leading to harvesting points outside of access barrier 411.

Indexer 600 may function similarly to, and/or be integrated within, loading junction 1200. For example, in addition to alternating among paths between penetration tubing 1100 and reservoir connector 1220, between penetration tubing 1100 and retrieval path 1210, and between penetration tubing 1100 and drive path/TIP tube 1310, loading junction 1200 may further create multiple penetration pathways 1100 leading to multiple respective instrumentation tubes 50. Loading junction 1200 including indexer 600 may be embodied in several different ways including multiple apparatuses 400, and/or 4100 disclosed in co-owned US Patent Publication 2011/0051875, Ser. No. 12/547,249, filed Aug. 25, 2009, incorporated by reference in its entirety, or other known devices for rerouting between pathways, including diverters, turntables, sorters, Gatling-type devices, etc. may be used in series to select between reservoirs 1270 and 1271, harvesting cask 1290, and drive mechanism 1300, all while further connecting that selection with a particular penetration tubing 1110 leading to/from a desired instrumentation tube 50.

Instrumentation tube indexer 600 may also be within access barrier 411 and separated from loading junction 1200, as shown in FIG. 2. This arrangement may permit all irradiation targets 250 being irradiated in multiple instrumentation tubes 50 to use a single penetration pathway 1100 when passing through access barrier 411, reducing the need for multiple penetrations through access barrier 411 and/or reducing the necessary size of such penetrations. Such an arrangement may be particularly advantageous if access barrier 411 is a containment building or critical safety element that requires as few penetrations as possible for minimal leakage and easy sealing. Indexer 600 may be a same or different type of apparatus as loading junction 1200, but reversed to split a single penetration pathway 1110 into multiple pathways connecting to multiple instrumentation tubes 50. For example, indexer 600 can be an apparatus from the incorporated 2011/0051875 document or another known multi-way valve, sorter, etc.

If positioned inside of access barrier 411, indexer 600 may be fabricated of materials generally compatible with an operating nuclear reactor environment and may be reliably operated remotely. Indexer 600 may be relatively small and, given the flexibility possible with penetration tubings 1110, may be positioned out of the way of other plant components while still connecting origin and harvesting points for irradiation targets 250 with multiple instrumentation tubes 50. Individual penetration tubings 1110 between indexer 600 and flanges 1110 of instrumentation tubes 50 may be installed or retrofitted from existing TIP tubing and generally sized and shaped to convey irradiation targets 250 to instrumentation tubes 50.

In addition to providing a plurality of penetration pathways 1100 to multiple irradiation tubes 50 for simultaneous irradiation of, and increased production of isotopes from, irradiation targets 250, indexer 600 may provide multiple penetration pathways for any driving force or drive system used to move irradiation targets 250 through example embodiment system 2000. For example, plunger 1350 of a TIP drive system 1300 or gravitational or pneumatic forces can move through an individual penetration pathway provided by indexer 600 to drive irradiation targets 250 into instrumentation tubes 50 and/or remove irradiation targets 250 therefrom and to a harvesting point outside of access barrier 411.

For some types of instrumentation tube indexers 600 and driving systems, it may not be possible to maintain a driving force to irradiation targets pushed through penetration pathway 1100 and indexer 600 and into a respective instrumentation tube 50. For example, drive 1300 and plunger 1350 driven thereby may be withdrawn back down through indexer 600 and out of penetration pathway 1100 in order to load irradiation targets 250 from a common origin point into other instrumentation tubes 50. As such, example embodiment system 2000 may further include one or more holding mechanisms to hold irradiation targets 250 in position within instrumentation tubes 50 for proper irradiation duration, so that other instrumentation tubes 50 may be loaded or evacuated through example system 2000 without requiring multiple driving systems. For example, indexer 600 itself may seal particular penetration pathways 1100 such that irradiation targets 250 cannot move past indexer 600 when held in instrumentation tubes 50. If indexer 600 is positioned closely enough to flanges 1110 and/or enough irradiation targets are inserted through indexer 600, indexer 600 itself may preserve irradiation targets 250 in instrumentation tubes 50 at desired positions and durations to form isotope products from the same simply by closing off penetration pathway 1100.

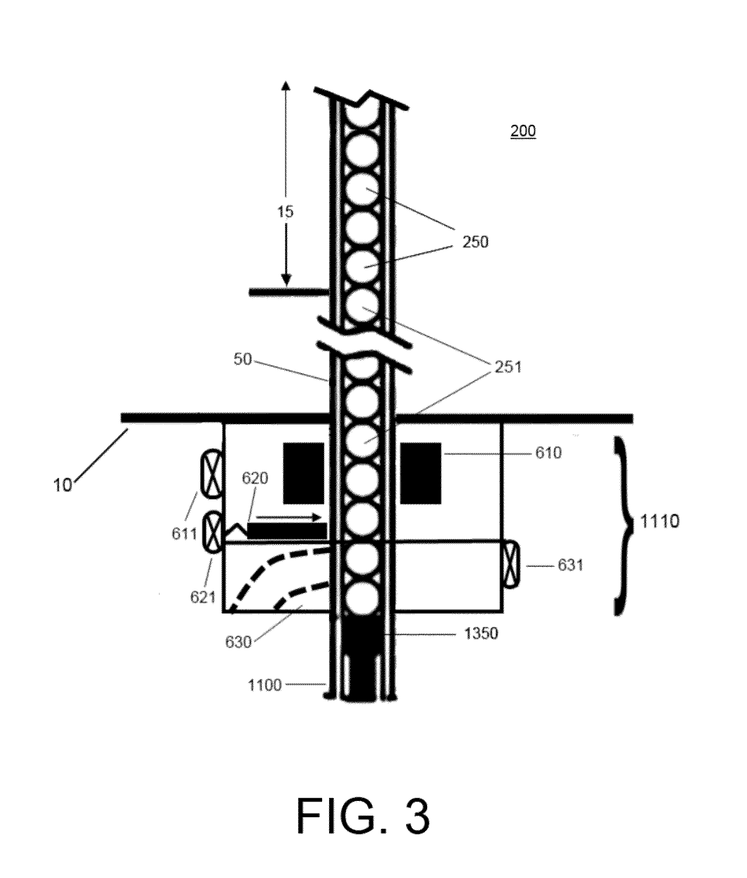

Alternately, or in addition, one or more holding mechanisms in detail 200 can be used at flanges 1110 to preserve irradiation targets 250 within instrumentation tubes 50. As shown in detail 200 of FIG. 3, one or more of a magnetic latch 610, pin 620, and valve 630 can be used at flange 1110 to hold irradiation targets 250 within instrumentation tubes 50. For example, a valve 630, such as a wye or other type of sealable diverter, can seal off a base of instrumentation tube 50 where it opens from reactor vessel 10 at flange 1110 so as to maintain irradiation targets 250 at desired positions in instrumentation tube 50. Valve 630 can also provide for alternate paths to preserve access to existing TIP tube indexers 55, or to provide alternate routing between instrumentation tube 50 and desired destinations, as shown by the dashed lines in valve 630 in FIG. 3.

Or, for example, a knife edge or pin 620 can be driven, by a spring or solenoid for example, into penetration tubing 1100 at flange 1110 and hold irradiation targets 250 in position thereabove in instrumentation tube 50. Still further, for example, a magnetic latch 610 may include one or more electromagnets that can be energized from a locally stored or remote energy source. Lower irradiation targets 250 and/or 251 formed of magnetic materials, or another magnetic barrier piece in penetration pathways 1100, may be held in place by the magnetic field and thus preserve positioning of all irradiation targets within instrumentation tube 50. Any of magnetic latch 610, pin 620, and valve 630, along with other holding devices, can be used alone or in combination to assure irradiation targets 250 remain at particular axial positions in instrumentation tube 50 during irradiation, without support of plunger 1350 or another drive mechanism, which can be used to drive other irradiation targets 250 into other desired instrumentation tubes 50.

When irradiation is complete or instrumentation tube 50 otherwise requires evacuation, whatever retaining mechanism is used can release irradiation targets 250 back into penetration pathway 1100 or another exit route, where they may be driven to harvesting points by gravity, pneumatic fluid injected into penetration pathway 1100, plunger 1350, or any other driving force. Local operation and release switches 611, 621, and 631 may be used to manually operate individual retaining mechanisms or can be remotely controlled by operators of system 2000 based on the status of system 2000 and a nuclear plant in which system 2000 operates.

Because retaining mechanisms that hold irradiation targets 250 within instrumentation tubes 50 during irradiation and potentially plant operation may be located within access barrier 411, which could be a containment building or radiological hazard area, for example, example system 2000 permits irradiation and desired daughter product creation within multiple instrumentation tubes 50 without the need for continuous opening or movement through penetrations in access barrier 411. For example, plunger 1350 can be fully withdrawn from access barrier 411 once irradiation targets 250 are secured in all instrumentation tubes 50 by indexer 600, magnetic latch 610, pin 620, and/or valve 630. Penetration pathway 1100 passing through access barrier 411 can be sealed and secured during this time, reducing leakage potential across access barrier 411 and overall reducing equipment presence and movement within access barrier 411.

Example embodiment system 2000 may further include multiple types of irradiation targets 250. For example, irradiation targets 250 may include positioning irradiation targets 251 usable to properly position other irradiation targets 250 for irradiation within instrumentation tubes 50. For example, positioning irradiation targets 251 may be fabricated of inexpensive, inert materials that will axially prop up irradiation targets 250 made of a parent material to be transformed through irradiation within instrumentation tubes 50, thus positioning the irradiation targets 250 at desired radiation positions within or near core 15. Positioning irradiation targets may further be fabricated of marker material or include an indicia or transmitter that permits easy location of a start/end of a series of irradiation targets 250 and 251 within example system 2000, permitting accurate positioning and movement of irradiation targets 250 and precise activation and release of any retaining mechanisms to ensure all targets have entered/exited instrumentation tubes 50 before closing/opening. Similarly, positioning irradiation targets 251 may be fabricated of magnetic materials in order to cooperate with a magnetic latch 610 useable in example embodiments, especially if other irradiation targets 250 are non-magnetic. Of course, positioning irradiation targets 251 may also be initially identical to irradiation targets 250 and still perform desired positioning and locating of all irradiation targets, because post-irradiation, the targets will have differing levels of activation that can be used to determine presence or position of all targets.

Positioning irradiation targets 251 may be introduced at a configured origin point to ensure proper positioning with irradiation targets 250. For example, a separate positioning target reservoir 1271 may house positioning irradiation targets 251 and dispense the same into reservoir connector 1220. A reservoir flow discriminator 1251 may count and/or adjust between irradiation targets 250 from regular irradiation target reservoir 1270 and positioning irradiation target 251 from positioning target reservoir 1271. Reservoir flow discriminator 1251 may be a wye valve, sorter, Gatling-type barrel, individual stop valves on each reservoir 1270 and 1271, etc. Reservoir flow discriminator 1251 may initially permit a number of irradiation targets 250 from reservoir 1270 to enter reservoir connector 1220 and pass through loading junction 1200 into penetration pathway 1100. Once a desired number of irradiation target 250 have been dispensed, such as a number of irradiation targets 250 required to axially fill a destination instrumentation tube 50 for an axial length of core 15, reservoir flow discriminator 1251 may stop flow from irradiation target reservoir 1270 and/or permit a desired number of positioning irradiation targets 251 from positioning target reservoir 1271 to follow the stream of irradiation targets 250 through reservoir connector 1220. The desired number of positioning irradiation targets may be a number required to fill a distance between a retaining mechanism and a bottom of core 15, so that all irradiation targets 250 are maintained within core 15. An example of such an arrangement is shown in FIG. 3.

Although two pairs of irradiation target reservoir 1270 and positioning target reservoir 1271 are shown connected to a loading junction 1200 and penetration tubing 1100 in FIG. 2, it is understood that only one or more than two of these structures may be used. Further, these structures may be connected to multiple penetration pathways 1100 and/or multiple indexers 600, such that a single pair of reservoirs 1270 and 1271 may supply irradiation targets 250 and 251 into multiple penetration pathways and instrumentation tubes 50 in reactor 10 and other destinations.

Once irradiation is complete and irradiation targets 250 are ready to be directed to harvesting points in example embodiment system 2000, indexer 600 may open penetration pathway 1100 between instrumentation tube 50 ready for harvesting and loading junction 1200, which may provide access to retrieval pathway 1210. All irradiation targets 250 and 251 in desired instrumentation tubes 50 may pass outside of access barrier 411 and into a harvesting cask 1290 through example system 2000. Irradiation positioning targets 251 may be easily sorted out of harvesting cask 1290 due to their markings or physical properties. Similarly, other discriminators and counters in loading junction 1200, retrieval pathway 1210, and/or at flange 1110 may selectively divert positioning irradiation targets 251 to alternate termination points to recycling or destruction, based on their physical properties or position.

Indexer 600, retention mechanisms at flange 1110, and/or individual penetration pathways 1100 for multiple instrumentation tubes 50 useable in example embodiments may be pre-existing in part and/or installed during access to containment areas and/or restricted access areas in a nuclear power plant, such as during a pre-planned outage. For example, retention mechanisms 610, 620, or 630 may be installed in about flanges 1110 during an outage in a drywell space 20 under reactor 10, along with portions of penetration tubing 1100 extending between instrumentation tubes 50 and indexer 600. Penetration tubing 1100 may be secured at various points inside access barrier 411 and/or skirt around existing equipment to minimize congestion or clutter in a drywell 20 or other space bounded by access barrier 411 while preserving a traversable path for irradiation targets 250 to and from instrumentation tubes 50.

Loading and offloading systems useable in example embodiments permit irradiation targets to be loaded in instrument tubes 50 for irradiation and withdrawn from tubes 50 and harvested after irradiation through a number of distinct penetration pathways 1100 based on their status and/or destination. Loading and offloading systems are operable during plant operation to properly load, guide, and harvest irradiation targets even when access to areas set off by access barrier 411 and instrumentation tubes 50 is limited. Any number of different sorting and/or directing mechanisms may be used as a loading and offloading system to achieve the desired movement of irradiation targets 250 and 251 within example embodiment systems.

Example embodiments and methods thus being described, it will be appreciated by one skilled in the art that example embodiments may be varied and substituted through routine experimentation while still falling within the scope of the following claims. For example, the types and numbers of penetration pathways, loading/offloading systems, and drive systems falling within the claims are not limited to the specific systems shown and described in the figures—other specific devices and systems for loading irradiation targets into an access-restricted area of a nuclear power station and instrumentation tubes for irradiation and offloading the same outside the access-restricted area for harvesting are equally useable as example embodiments and fall within the scope of the claims. Such variations are not to be regarded as departure from the scope of the following claims.

What is claimed is:

1. A system for delivering and retrieving irradiation targets through a nuclear reactor, the system comprising:
a loading/offloading system including a first distinct path and a second distinct path traversable by the irradiation targets, wherein the loading/offloading system is outside of an access barrier of the nuclear reactor;
a plurality of penetration pathways each connecting the loading/offloading system to one of a plurality of instrumentation tubes extending into the nuclear reactor inside the access barrier, wherein each of the penetration pathways is traversable by the irradiation targets to the instrumentation tube, wherein,
the first distinct path connects an irradiation target source to the penetration pathways,
the second distinct path connects the penetration pathways to an irradiation target harvesting point outside the access barrier, and
the loading/offloading system is configured to provide one of the distinct paths based on a destination of the irradiation targets; and
an indexer connected to the penetration pathways, wherein the indexer is configured to provide one of the penetration pathways for the irradiation targets to move into/out of a corresponding one of the instrumentation tubes.

2. The system of claim 1, wherein the penetration pathways include,
a single penetration tubing connecting the loading/offloading system with the indexer, and
multiple penetration tubings connection the indexer to each of the instrumentation tubes.

3. The system of claim 2, wherein, the indexer is within an area bounded by the access barrier, and wherein the single penetration tubing extends through a penetration in the access barrier and to the indexer.

4. The system of claim 1, wherein the indexer is configured to retain the irradiation targets within one of the instrumentation tubes when the one of the penetration pathways provided by the indexer is not to the one instrumentation tube.

5. The system of claim 1, further comprising:
a retention mechanism positioned in one of the penetration pathways at an opening of the corresponding instrumentation tube, wherein the retention mechanism is configured to prevent the irradiation targets from moving past the retention mechanism in the one of the penetration pathways.

6. The system of claim 5, wherein the retention mechanism includes at least one of a valve, a pin, and a magnetic latch.

7. The system of claim 5, wherein the retention mechanism includes a wye valve positionable to one of,
prevent the irradiation targets from moving past the valve in the one of the penetration pathways,
permit the irradiation targets to move past the valve in the one of the penetration pathways, and
permit the irradiation targets to move outside the system at the valve.

8. The system of claim 1, further comprising:
a plurality of irradiation targets that convert to a desired daughter product after being exposed to radiation in an operating nuclear reactor; and
at least one positioning irradiation target that substantially maintains its physical properties when exposed to radiation in an operating nuclear reactor.

9. The system of claim 8, further comprising:
a plurality of positioning irradiation targets, wherein the positioning irradiation targets have a length that maintains the irradiation targets within core axial positions when the positioning irradiation targets and the irradiation targets are maintained in the instrumentation tubes, and wherein the positioning irradiation targets include indicia that permits detection of a location of the positioning irradiation targets in the penetration pathways.

10. The system of claim 8, further comprising:
the irradiation target source, wherein the irradiation target source includes a reservoir containing the irradiation targets and a reservoir containing the positioning irradiation targets.

11. The system of claim 10, wherein the irradiation target source further includes a discriminator configured to move a desired number of the irradiation targets into the first distinct path followed by a desired number of the positioning irradiation targets.

12. The system of claim 1, further comprising:
a seal on the access barrier configured to isolate an area within the access barrier when the irradiation targets are being irradiated in the instrumentation tubes.

13. A method of processing irradiation targets through a nuclear reactor to generate isotope products, the method comprising:
creating a first penetration pathway from outside an access barrier of the nuclear reactor to a first instrumentation tube of the nuclear reactor;
moving a first irradiation target into the first instrumentation tube through the first penetration pathway;
creating a second penetration pathway from outside the access barrier to a second instrumentation tube of the nuclear reactor; and
moving a second irradiation target into the second instrumentation tube through the second penetration pathway.

14. The method of claim 13, wherein the first and the second penetration pathways are created by an indexer positioned within the access barrier.

15. The method of claim 13, further comprising:
engaging a first retainer mechanism in the first penetration pathway to maintain the first irradiation target in the first instrumentation tube; and
engaging a second retainer mechanism in the second penetration pathway to maintain the second irradiation target in the second instrumentation tube.

16. The method of claim 15, wherein the moving the first irradiation target into the first instrumentation tube includes driving the first irradiation target with a plunger in the first penetration pathway, and wherein the moving the second irradiation target into the second instrumentation tube includes driving the second irradiation target with the plunger in the second penetration pathway while the first irradiation target is maintained in the first instrumentation tube by the first retainer mechanism.

17. The method of claim 13, further comprising:
introducing a plurality of the first irradiation targets into the first penetration pathway from a first reservoir;
introducing a plurality of first positioning targets into the first penetration pathway from a second reservoir;
moving the first irradiation targets and the first positioning targets into the first instrumentation tube through the first penetration pathway;
introducing, while the first irradiation and positioning targets are in the first instrumentation tube, a plurality of second irradiation targets into the second penetration pathway from the first reservoir; and
introducing, while the first irradiation and positioning targets are in the first instrumentation tube, a plurality of second positioning targets into the second penetration pathway from the second reservoir.

18. The method of claim 17, wherein the first penetration pathway and the second penetration pathway share a tubing from the first and second reservoirs.

19. The method of claim 13, further comprising:
irradiating the first irradiation target in the first instrumentation tube by maintaining the first irradiation target in the instrumentation tube so as to substantially convert the first irradiation target into desired daughter products with radiation from a core of the nuclear reactor; and
irradiating, simultaneously with the irradiation of the first irradiation target, the second irradiation target in the second instrumentation tube by maintaining the second irradiation target in the instrumentation tube so as to substantially convert the second irradiation target into desired daughter products with radiation from the core of the nuclear reactor.

20. The method of claim 19, further comprising:
creating a first exit pathway from the first instrumentation tube to a harvesting area outside of the access barrier;
harvesting the irradiated first irradiation targets by moving the irradiated first irradiation targets to the harvesting area through the first exit pathway;
creating a second exit pathway from the second instrumentation tube to the harvesting area outside of the access barrier;
harvesting the irradiated second irradiation targets by moving the irradiated second irradiation targets to the harvesting area through the second exit pathway, wherein the first exit pathway and the second exit pathway share a single tubing between the access barrier and the harvesting area.
